(19) United States
(12) Patent Application Publication
(10) Pub. No.: US 2008/0111385 A1
(43) Pub. Date: May 15, 2008

(54) Method for manufacturing impact absorber for vehicle

(75) Inventors: Shinichi Haneda, Anjo-shi (JP); Kiyoichi Kita, Takaoka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: Aisin Seiki Kabushiki Kaisha; Aisin Keikinzoku Kabushiki Kiasha

(21) Appl. No.: 11/979,909

(22) Filed: Nov. 9, 2007

(30) Foreign Application Priority Data
Nov. 10, 2006 (JP) 2006-305736

(51) Int. Cl. B60R 19/02

(52) U.S. Cl. 293/102

(57) ABSTRACT

A method for manufacturing an impact absorber for a vehicle includes a first process for manufacturing a formed body having a constant cross-sectional configuration by performing roll forming on a metal sheet and a second process for manufacturing the impact absorber by performing an induction hardening treatment and a bend forming on the formed body after performing the first process.

### CROSS REFERENCE TO RELATED APPLICATIONS

This application is based on and claims priority under 35 U.S.C. § 119 to Japanese Patent Application 2006-305736, filed on Nov. 10, 2006, the entire content of which is incorporated herein by reference.

### FIELD OF THE INVENTION

This invention generally relates to a method for manufacturing an impact absorber for a vehicle.

### BACKGROUND

Among related manufacturing methods for impact absorbers for vehicles, for example, a method described in JP2846983B is known. According to the manufacturing method described in JP2846983B, a bumper reinforcement serving as an impact absorber is manufactured by rolling and forming a high tensile steel plate having 450 MPa or higher tensile strength and less than 2.54 mm of thickness so that the formed body has a constant cross sectional configuration in a longitudinal direction thereof, and then by bending the formed body so that the body is formed in an arc-shape (sweep forming) with a constant curvature radius in the longitudinal direction thereof (in a direction perpendicular to the cross section of the body). Here, the bumper reinforcement (the formed body) shown in cross-section includes indentations on a front wall and a rear wall respectively. The JP2846983B also discloses that the indentations serve as a roller engaging portion which is configured to engage with a roller for advancing the formed body forward during bending and forming of the formed body.

From viewpoints of formability and cost, a limit tensile strength of the high tensile steel plate that undergoes a roll forming process is about 980 MPa. In JP2846983B, the high tensile steel plate needs to be thick to satisfy strength required for the bumper reinforcement, which increases thickness of the bumper reinforcement 1, thus causing weight increment thereof.

A need thus exists for a method for manufacturing an impact absorber for a vehicle, which is not susceptible to the drawback mentioned above.

### SUMMARY OF THE INVENTION

In light of the foregoing, a method for manufacturing an impact absorber for a vehicle includes a first process for manufacturing a formed body having a constant cross-sectional configuration by performing roll forming on a metal sheet and a second process for manufacturing the impact absorber by performing an induction hardening treatment and a bend forming on the formed body after performing the first process.

### BRIEF DESCRIPTION OF THE DRAWINGS

FIG. 1 is a perspective view illustrating a bumper reinforcement according to the embodiment of the invention.

FIG. 2 is a cross section view illustrating the bumper reinforcement.

FIG. 3 is a side view illustrating a manufacturing apparatus according to the embodiment of the invention.

FIG. 4A is a cross section view illustrating a formed body during manufacture.

FIG. 4B is a cross section view illustrating a formed body during manufacture.

FIG. 4C is a cross section view illustrating a formed body during manufacture.

FIG. 4D is a cross section view illustrating a formed body during manufacture.

FIG. 5A is a plan view illustrating an action of the prior art.

FIG. 5B is a plan view illustrating an action of the invention.

FIG. 6 is a graph showing the correlation between deformation and load.

### DETAILED DESCRIPTION

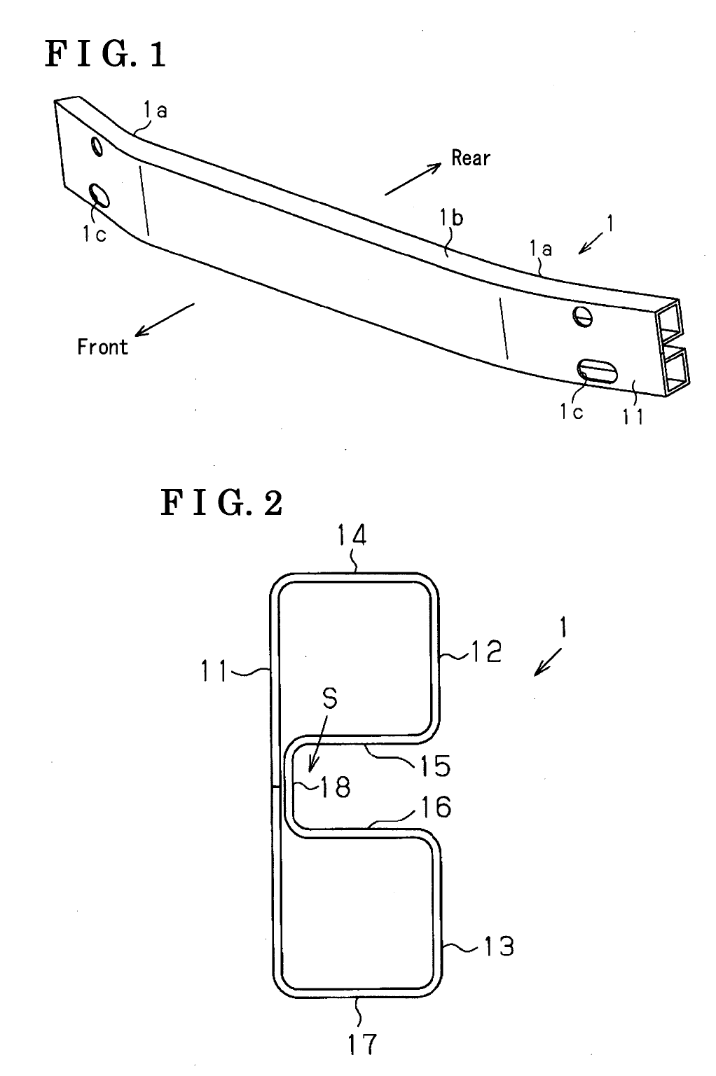

FIGS. 1 and 2 are a perspective view and a cross section view respectively illustrating a bumper reinforcement 1 manufactured by a manufacturing method for an impact absorber for a vehicle according to the present invention. The bumper reinforcement 1 is adapted for a bumper device to be mounted to a front portion of a vehicle for absorbing impact applied mainly from a front of a vehicle.

As shown in FIGS. 1 and 2, the bumper reinforcement 1 is made of a band-shaped high tensile steel plate and made into a lengthy, hollow structure. The bumper reinforcement 1 includes a front wall 11 serving as a receiving surface of a load applied from a forward of the vehicle, a pair of rear walls 12, 13 arranged vertically to each other on a mounting surface to the vehicle and parallelly opposing to the front wall 11 respectively, a pair of upper walls 14, 15 connecting the upper rear wall 12 and the front wall 11, and a pair of lower walls 16, 17 connecting the lower rear wall 13 and the front wall 11, thus the bumper reinforcement 1 having a constant cross sectional configuration, like a letter B, in a longitudinal direction thereof.

A height of the front wall 11 is set to be larger than a combined height of the rear walls 12, 13. The bumper reinforcement 1 includes a connecting wall 18 interposed between the upper wall 15 and the lower wall 16, the connecting wall 18 connecting the upper wall 15 and the lower wall 16, and contacting the front wall 11. The upper wall 15, the lower wall 16 and the connecting wall 18 thereby form a recess portion S opening rearward and having a U-shaped cross section. The bumper reinforcement 1 is formed in a manner that both ends of a piece of metal sheet are joined at the center of the front wall 11 contacting the connecting wall 18, the front wall 11 welded to the connecting wall 18. Thus, a cross section of the bumper reinforcement 1 is a continuous line.

An upper enclosed region formed by the front wall 11, the rear wall 12, and the upper walls 14 and 15 has a square cross section. Similarly, a lower enclosed region formed by the front wall 11, the rear wall 13, and the lower walls 16 and 17 has a square cross section. The vertically arranged square enclosed regions are separated from each other in vertical direction by a height of the connecting wall 18.

As shown in FIG. 1, the bumper reinforcement 1 includes bent portions 1a, 1a respectively at both ends in the longitudinal direction thereof, and the both ends of the bumper reinforcement 1 are inclined rearward in the vehicle's longitudinal direction at the bent portions 1a, 1a to match a shape of a vehicle front portion. The bumper reinforcement 1 includes a straight portion 1b located at a center thereof and extending linearly in the longitudinal direction thereof, namely, extending between the bent portions 1a, 1a. That is, the bumper reinforcement 1 is bent at two portions. The bumper reinforcement 1 includes mounting holes 1c, 1c for mounting the bumper reinforcement 1 to a vehicle body.

A method for manufacturing the bumper reinforcement 1 will be described herebelow.

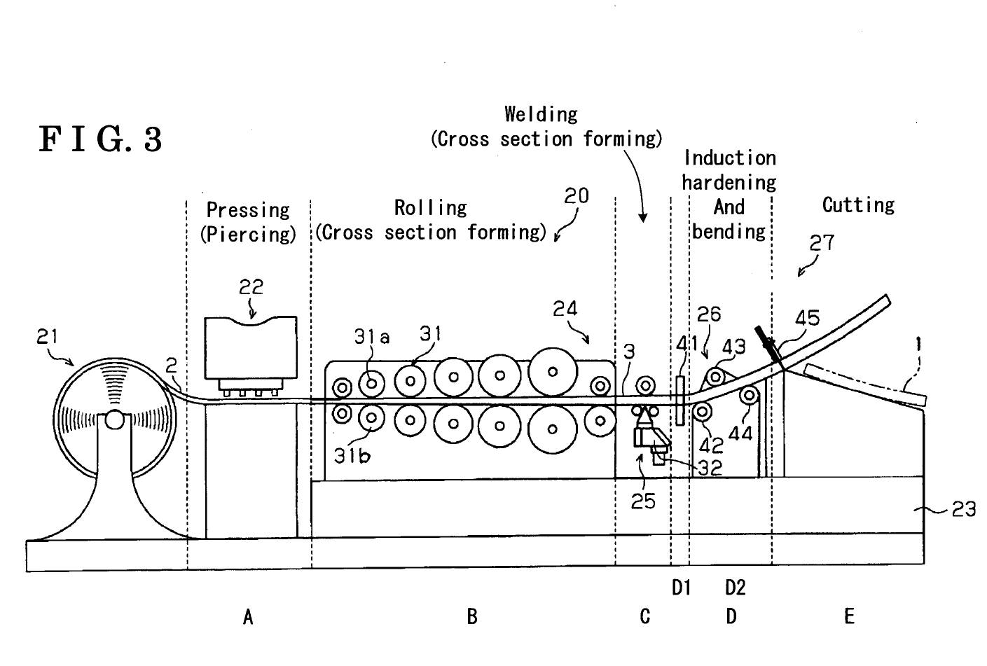

FIG. 3 is a side view schematically showing a manufacturing apparatus 20 used for the manufacturing method for the bumper reinforcement 1 according to the embodiment. As shown in FIG. 3, the manufacturing apparatus 20 includes an uncoiler 21 wound with a metal sheet 2 made of the high tensile steel plate, a piercing machine 22, a roll forming machine 24 mounted on a support 23, a laser welder 25, an induction hardening and bend forming machine 26 and a cutter 27. The method for manufacturing the bumper reinforcement 1 includes a pressing (piercing) process A performed by the piercing machine 22, a rolling (cross section forming) process B serving as a first process and performed by the roll forming machine 24, a welding (cross section forming) process C performed by the laser welder 25, an induction hardening and bending process D serving as a second process and performed by the induction hardening and bend forming machine 26, and a cutting process E performed by the cutter 27.

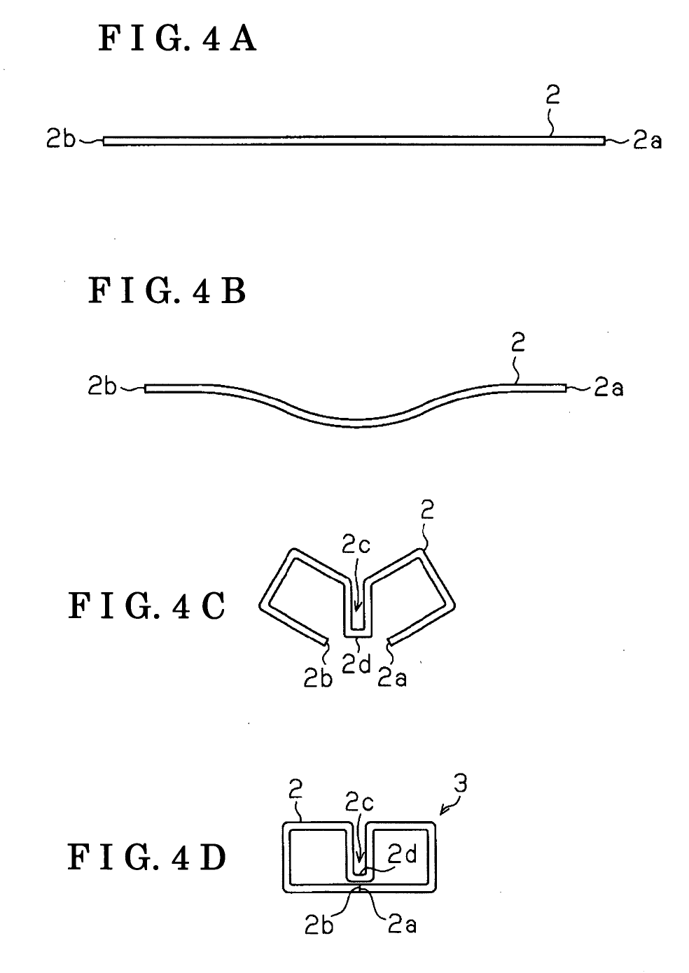

The piercing machine 22 make holes on the metal sheet 2 fed out from the uncoiler 21, which correspond to the mounting holes 1c, 1c. The roll forming machine 24 includes a plurality of roller units 31 each having a pair of rollers 31a and 31b arranged vertically to each other, the roller units 31 aligned horizontally. As shown in FIGS. 4A, 4B, 4C and 4D, the metal sheet 2 is gradually folded in a width direction thereof as being advanced from the piercing machine 22 through the pairs of rollers 31a and 31b. As shown in FIG. 4D, the metal sheet 2 is thereby formed into a formed body 3 having a constant cross sectional configuration in a longitudinal direction thereof, which corresponds to the cross sectional configuration of the bumper reinforcement 1. The formed body 3 includes a formed portion 2c opening upward and corresponding to a recessed portion S of the bumper reinforcement 1. The formed body 3 also includes ends 2a, 2b in the width direction of the metal sheet 2, the ends 2a, 2b butted and joined together and contacting a formed portion 2d that corresponds to the connecting wall 18 of the bumper reinforcement 1.

The laser welder 25 includes a welding nozzle 32 that emits laser light upward, with which the matched ends 2a, 2b of the formed body 3 fed out from the roll forming machine 24 are butt-welded to the formed portion 2d. Accordingly, the formed body 3 is provided with a closed cross section.

The induction hardening and bend forming machine 26 includes a high frequency ring 41, and three bending rollers 42, 43 and 44 that are movable in three directions. On the induction hardening and bend forming machine 26, the formed body 3 fed out from the laser welding machine 25 is performed with an induction hardening treatment by a high frequency wave emitted by the high frequency ring 41 (a hardening process D1). Then, the formed body 3 is moved forward between the bending rollers 42, 44 and the bending roller 43, and thus the formed body 3 is bent at portions where the hardening is performed in the hardening process, more particularly, at portions corresponding to the bent portions la, la (a bending process D2) (refer to FIG. 1). At this time, the formed body 3 is heated and softened during the induction hardening treatment, thereby bent and formed smoothly in the longitudinal direction thereof. A tensile strength of the formed body 3 increases steeply, for example, from approximately 400 MPa before the induction hardening treatment to approximately 1,500 MPa after the treatment.

The cutter 27 cuts off the formed body 3, fed out from the induction hardening and bend forming machine 26, with a blade 45 into an individual bumper reinforcement 1 having a predetermined length in the longitudinal direction thereof.

Manufacturing processes for making the bumper reinforcement 1 from the metal sheet 2 are thereby completed. In sum, the plurality of bumper reinforcements 1 are continuously manufactured by advancing the metal sheet 2 wound on the uncoiler 21 through the manufacturing apparatus 20.

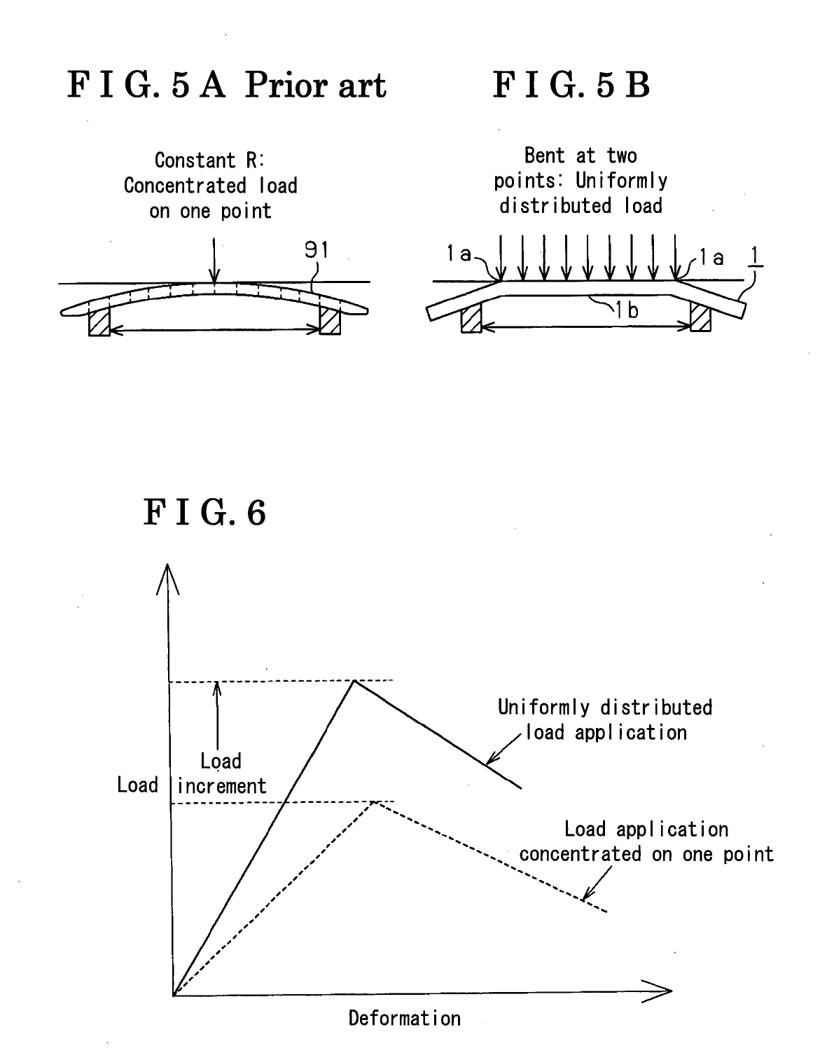

Next, a function of the bumper reinforcement 1 bent at the two portions will be described based on FIGS. 5 and 6.

FIG. 5A is a plan view illustrating a bumper reinforcement 91 according to the prior art, which is bent and formed into an arc-shape having a constant curvature radius. FIG. 5B is a plan view illustrating the bumper reinforcement 1 according to the present invention, which is bent at the two portions. These bumper reinforcements 1 and 91 include an identical cross sectional configuration. As shown in FIG. 5A, when a load is applied to the bumper reinforcement 91 at a time of vehicle crash or the like, the bumper reinforcement 91 is likely to break because the load is concentrated on one point. On the other hand, the bumper reinforcement 1 according to the present embodiment is less likely to break because a load applied thereto at the time of vehicle crash or the like is evenly distributed (uniform distribution) on the straight portion 1b.

FIG. 6 is a graph showing the correlation between the load applied to the bumper reinforcement 1 and 91 respectively and corresponding deformation. As is evidently confirmed from FIG. 6, a uniformly distributed load application to the bumper reinforcement 1, which is indicated by a solid line, has less deformation compared to a load application concentrated on one point of the bumper reinforcement 91, which is indicated by a dashed line.

According to the present embodiment, advantages stated below are obtained.

(1) According to the present embodiment, the metal sheet 2 with a relatively low strength, for example a tensile strength of 400 MPa, is simply roll-formed into the formed body 3 in the rolling process B. After that, the formed body 3 is made into the bumper reinforcement 1 by undergoing the induction hardening treatment in the induction hardening and bending process D, thus increasing tensile strength of the bumper reinforcement 1 up to around 1500 MPa. Consequently, the bumper reinforcement 1 satisfying a required strength and having less thickness, i.e. less weight, is manufactured. Meanwhile, restrictions posed on the tensile strength (formability) relating to roll forming is alleviated. In the induction hardening and bending process D, the formed body 3 is heated and softened so as to be smoothly bent and formed in the longitudinal direction thereof.

(2) According to the present embodiment, the bumper reinforcement 1 includes the straight portion 1b located at the center thereof and extending linearly in the longitudinal direction thereof. Consequently, when a load is applied to the bumper reinforcement 1 (the straight portion 1b) in a thickness direction of the bumper reinforcement 1 (i.e. from a forward direction of the vehicle), the load is evenly distributed on the straight portion 1b, thereby restraining the bumper reinforcement 1 from being bent into two portions at one point where the load is concentrated (bent in an approximately V-shape). And thus the impact absorber for the vehicle, which satisfies the required strength is manufactured with less thickness, i.e. less weight.

(3) According to the present embodiment, the formed body 3 (the bumper reinforcement 1) includes the vertically arranged two constant square cross sectional configurations in the longitudinal direction thereof, which is ideal to efficiently increase a geometrical moment of inertia and a section modulus with reference to a center of gravity of the cross sectional configuration, i.e. section strength. The bumper reinforcement 1 is thereby manufactured to have less thickness, i.e. less weight, while satisfying the required strength. In other words, the bumper reinforcement 1 has improved section strength compared to that of the bumper reinforcement 91 according to the prior art where the constant cross sectional configuration is formed by oblique walls made by chamfering the indentations and corners.

Further, the formed body 3 (the bumper reinforcement 1) includes the vertically arranged two constant square cross sectional configurations in the longitudinal direction thereof, which causes less deformation compared to a larger cross section, thereby preventing local deformation.

(4) According to the present embodiment, the induction hardening and bending process D enables the formed body 3 to be bent and formed in multiple degrees of freedom by using the three bending rollers 42, 43 and 44 that are movable in three directions, and thus increasing flexibility in designing and enhancing support for aesthetic design.

The above described embodiment may be modified as follows:

The cross sectional configuration of the formed body 3 (the bumper reinforcement 1) formed in the rolling process B is an example. The formed body 3 does not have to include either the constant square cross sectional configuration in the longitudinal direction or a closed cross sectional configuration.

In the induction hardening and bending process D, the formed body 3 may be bent and formed to be a bumper reinforcement having a constant curvature radius in the longitudinal direction thereof or to be a bumper reinforcement bent at four portions.

The bumper reinforcement 1 may be adapted for a bumper device for a vehicle, which is mounted to a back of the vehicle. The impact absorber for the vehicle may be a reinforcing member for a vehicle door mounted to a side of the vehicle (so called a door beam).

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A method for manufacturing an impact absorber for a vehicle, comprising:
a first process for manufacturing a formed body having a constant cross-sectional configuration by performing roll forming on a metal sheet; and
a second process for manufacturing the impact absorber by performing an induction hardening treatment and a bend forming on the formed body after performing the first process.

2. The method for manufacturing the impact absorber for the vehicle according to claim 1, wherein the second process includes:
a hardening process for performing the induction hardening treatment on the formed body; and
a bending process for performing the bend forming on the formed body after the hardening process.

3. The method for manufacturing the impact absorber for the vehicle according to claim 2, wherein the bend forming is performed, in the bending process, on the formed body at a portion where the hardening treatment is performed in the hardening process.

4. The method for manufacturing the impact absorber for the vehicle according to claim 1, wherein the bend forming is performed on the formed body so that the impact absorber includes a straight portion located at a center thereof and extending linearly in a longitudinal direction thereof.

5. The method for manufacturing the impact absorber for the vehicle according to claim 2, wherein the bend forming is performed on the formed body by means of the bend forming so that the impact absorber includes a straight portion located at a center thereof and extending linearly in a longitudinal direction thereof.
